(19) United States
(12) Patent Application Publication
(10) Pub. No.: US 2014/0047332 A1
(43) Pub. Date: Feb. 13, 2014

(54) E-READER SYSTEMS

(71) Applicant: MICROSOFT CORPORATION, Redmond, WA (US)

(72) Inventors: Ming Liu, Redmond, WA (US); Wei Zeng, Redmond, WA (US); Raman Narayanan, Redmond, WA (US); Sergey Chub, Redmond, WA (US); Radoslav Petrov Nickolov, Redmond, WA (US)

(73) Assignee: Microsoft Corporation, Redmond, WA (US)

(21) Appl. No.: 13/677,760

(22) Filed: Nov. 15, 2012

Related U.S. Application Data
(60) Provisional application No. 61/681,094, filed on Aug. 8, 2012.

(51) Int. Cl. G06F 17/21

(52) U.S. Cl. CPC G06F 17/212
USPC 715/273

(57) ABSTRACT

E-reader architecture with rich service infrastructure for identity, storage, protection, commercial exchange, and sharing of content is provided. The architecture may enable consumption of content through a set of compatible cross-platform consumption experiences that provide easy access to professional, institutional, collaborative or personal content with auxiliary capabilities such as search, commenting, posting, and similar ones.

### CROSS REFERENCE TO RELATED APPLICATIONS

This application claims the benefit of U.S. Provisional Patent Application Ser. No. 61/681,094 filed on Aug. 8, 2012. The disclosures of the provisional patent application are hereby incorporated by reference for all purposes.

### BACKGROUND

With the proliferation of computing and networking technologies, various forms of content are increasingly being provided to users through a multitude of devices and platforms. For example, electronic books are quickly replacing paper books as preferred forms of textual/graphics content dissemination. Different aspects of electronic book consumption result in a variety of types of platforms for delivering electronic book content to users. For example, some electronic book reader devices emphasize outdoor reading with specialized displays, while others emphasize portability with smaller form factors. These specialized devices have corresponding shortcomings such as lack of color, detail, etc.

Furthermore, electronic books are only one type of content. Magazines, newspapers, personal or business documents, and many other forms of content are exchanged every day, but electronic reader devices are typically limited to a subset of those. Platforms that provide some variety of content tend to have limitations on presentation, interaction, and other user experience aspects.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a rich service infrastructure for identity, storage, protection, commercial exchange, and sharing of content through a set of compatible cross-platform consumption experiences that provide easy access to professional, institutional, collaborative or personal content with auxiliary capabilities such as search, commenting, posting, and similar ones.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example e-reader display with a variety of content and example commands available to a user on selected text;

FIG. 2 illustrates another example e-reader display with a search pane;

FIG. 3 illustrates a further example e-reader display with a commenting and/or sharing pane;

FIG. 4 illustrates major components and interactions in an example e-reader service architecture according to some embodiments;

FIG. 5 illustrates an example home page view of an e-reader application user interface;

FIG. 6 illustrates an example my bookshelf page view of an e-reader application user interface;

FIG. 7 illustrates an example bookstore view of an e-reader application user interface with available books sorted according to genre;

FIG. 8 illustrates an example my library view of an e-reader application user interface with available books sorted alphabetically;

FIG. 9 illustrates an example e-reader application user interface with a variety of content and interaction controls for different types of content;

FIG. 10 conceptually illustrates secure processing of content through web context and local context;

FIG. 11 is a networked environment, where a system according to embodiments may be implemented;

FIG. 12 is a block diagram of an example computing operating environment, where embodiments may be implemented; and

FIG. 13 illustrates a logic flow diagram for a process of providing an e-reader service according to embodiments.

### DETAILED DESCRIPTION

As briefly described above, a rich e-reader service infrastructure may be provided for identity, storage, protection, commercial exchange, and sharing of content for easy access to professional, institutional, collaborative or personal content with additional capabilities such as search, commenting, posting, and similar ones.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a removable memory device, and a flash drive.

Throughout this specification, the term “platform” may be a combination of software and hardware components for providing e-reader services such as content delivery, security features, user experience elements, and comparable ones. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

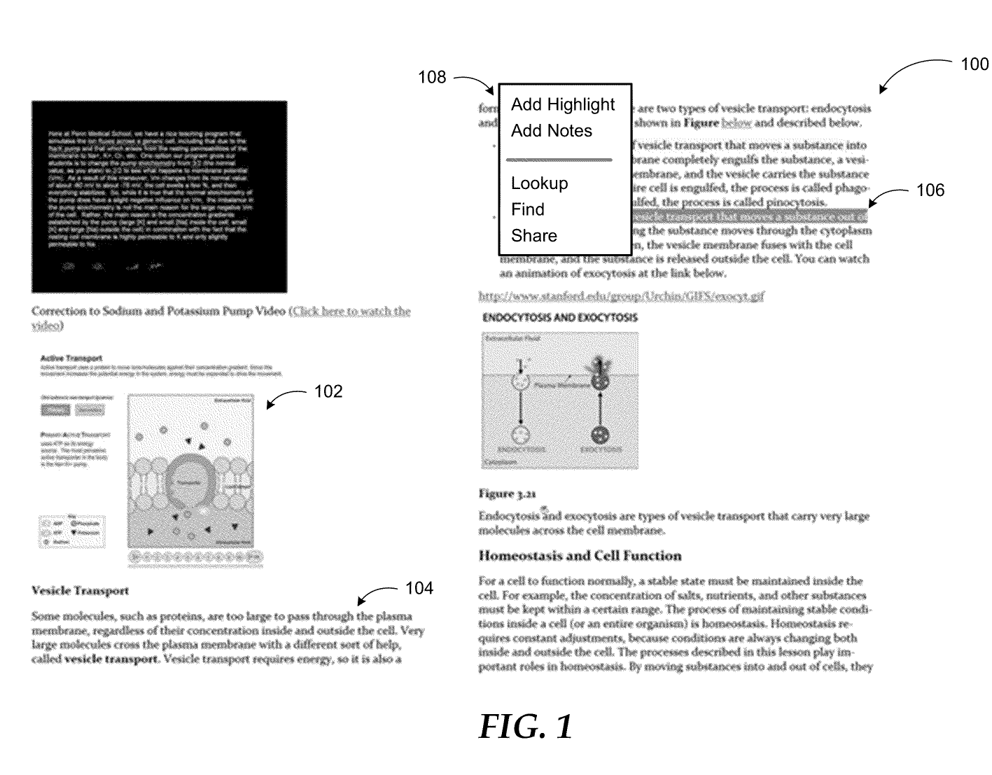

FIG. 1 illustrates an example e-reader display with a variety of content and example commands available to a user on selected text.

Diagram 100 shows an example e-reader user interface according to some embodiments displaying book content. In addition to other types of content discussed below, the example content in diagram 100 includes textual content 104 and images 102. The images 102 may have interactive elements or may even be movies or slide shows. Upon selection of a portion of the displayed content 106, an e-reader application may present a command menu 108 with available commands depending on the selection type. For example, for a selection of textual content, the available commands may include “Add Highlight”, “Add Notes”, “Lookup”, “Find”, and “Search.”

An example e-reader architecture may provide a set of compatible cross-platform consumption experiences for a variety of desktop, mobile, and hosted operating platforms. The architecture may also provide easy access to professional, institutional, collaborative, and/or personal content and support for content protection technologies (e.g., digital rights management “DRM”). Furthermore, a rich service infrastructure may be provided for identity, storage (of content and comment), commercial exploitation, content protection, synchronizing, and sharing of content.

An example e-reader according to embodiments may support standardized formats or proprietary formats for different categories. For example, professional content (books and magazines) may use EPUB2, EPUB3, PDF standards; institutional content (academic, trade publications) may use PDF, DOCX standards; collaborative content may use DOCX, PDF standards; and personal content may use DOCX, PDF standards, among others.

EPUB enables packaging of websites in an offline package. The standard includes a compressed (zip) file with XHTML documents, which host the book content, packaging files that contain book metadata and describe the structure of the book, and container files that describe the root pointer to the content and any content protection scheme. EPUB provides for reflowable text that can be read optimally on a variety of reading systems. EPUB3 facilitates creation of books with modern content. The base content format is HTML and supports SVG objects, MathML, CSS3, and scriptable behaviors. With the upgrades in content format, navigation, scripting, styling, media, and character sets, EPUB3 facilitates creation of compelling book content. Thus, EPUB3 naturally lends itself to ‘active reading’.

An e-reader architecture according to some embodiments may enable a user to browse a book store and purchase a book (downloaded to the local machine for offline use); render compliant EPUB2 and EPUB3 content; render modern content found in compliant EPUB3 (HTML5, media, interactive JS objects) with full fidelity; adjust fonts/sizes for enhanced readability (content re-flowing intelligently to suit the font/size/viewing area; create text annotations anchored to specific content; create full page notes (text and ink) anchored to a specific page in the book; markup ‘content of interest’ by highlighting or underlining; call up notes or annotations when the content of interest is in view; and/or synchronize annotations and full page notes across all devices of the user running the reader application.

An e-reader architecture according to other embodiments may enable a user to look up content of interest with web search results shown within the reading experience; search content of the books in the library and notes along with a web search during the lookup process; upload a word processing document and have it converted to EPUB3 or similar standardized format and placed in user library; upload a PDF document and have it converted to EPUB3 and placed in user library; annotate the converted PDF and word processing documents; and/or customize reading experience (page background, line spacing, margin/gutter width, text color). The above-discussed document formats are illustrative examples only, and are not intended to limit embodiments. Indeed, any document format may be processed, presented, and subject to various features of an e-reader as discussed herein. The architecture may allow the e-reader application or service to provide support for various document formats out-of-the-box, through upgrades, or through third party plug-ins.

An e-reader architecture according to further embodiments may enable a user to customize user generated content (ink color and stroke width, eraser width, text color, font, size); lasso-select an area of the book and drag it to the note section; add existing or captured audio/video stream to note; format notes with decorations like bold, italic, colors, font/size changes etc.; export annotations to a note taking application or any other program capable of receiving all annotation content types (ink, text, image, link, audio, video); synchronize annotations to a pre-configured friends' book; conduct a live chat from within the reader experience; share a uniform resource locator (URL) that links to annotation and content of interest thru email or by posting to a social web site; and/or share the screen with real time annotations appearing during the chat session.

The active reading experience provided by the architecture may cover core reading experience, note taking, research and reference, social sharing, and aggregating user content along with professional content. Various visual schemes may be implemented to display available content such as 3D schemes, shading schemes, color schemes, textual scheme, graphical schemes, etc., which may be complemented by audio/video features. A navigation bar may present actual page number of a presented document. An interactive Table of Contents may be updated automatically through a script.

Users may be enabled to add notes, add highlights, add annotations, etc. (through keyboard entry or ink entry), which may be stored locally and/or in the cloud. Provided content may be interactive. For example, users may solve puzzles, take tests, provide comments, etc., which may be sent to the content source or designated destinations (e.g., a textbook may include tests, results of which may be sent to a professor).

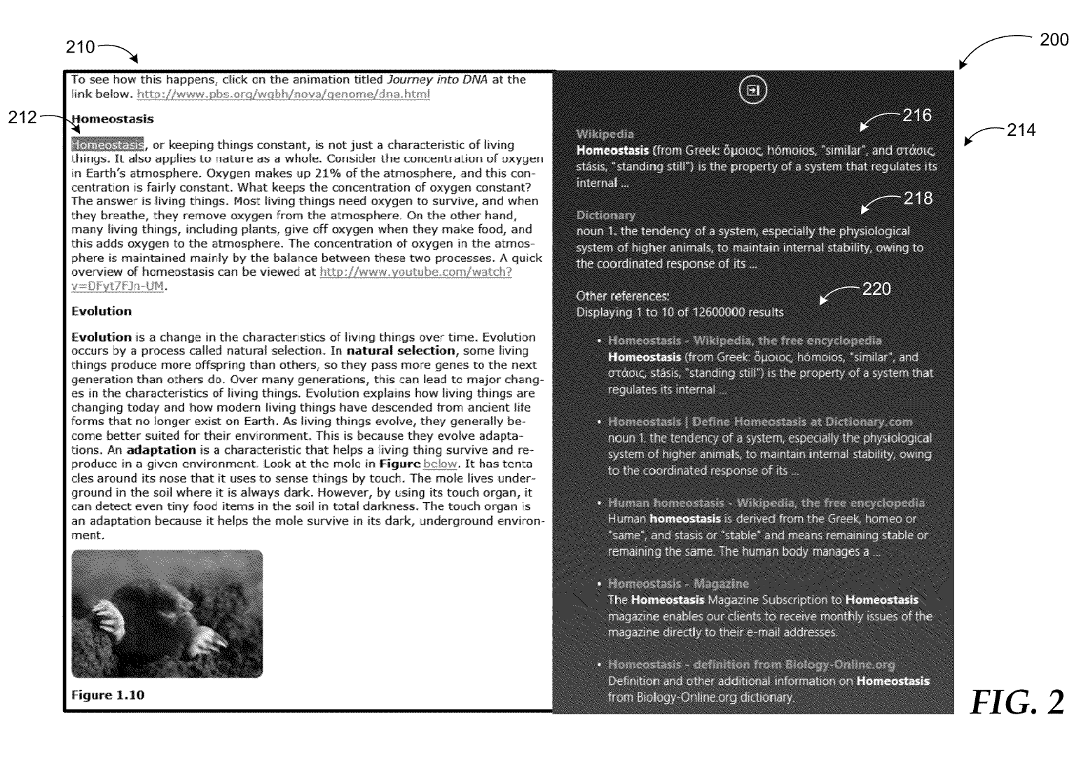

FIG. 2 illustrates another example e-reader display with a search pane.

Diagram 200 shows an example e-reader user interface, where a book (or magazine) content is displayed with textual and image elements and a search pane displaying search results for selected content on the user interface. For example, the word “Homeostasis” (212) is selected on the displayed content 210. The search results displayed in the search pane 214 may be grouped by category such as results from Wikipedia (216), results from an online dictionary (218), and/or other references (220).

Context based search within the content may be enabled in an e-reader architecture according to embodiments and search capabilities enhanced using the content and user information. For example, a selected word may be searched online and/or through user's domain based on the context of content around that word. Results may be provided in categories such as images, maps, text, scholarly articles, etc. based on the context and/or user preferences.

In yet other embodiments, flat books (non-interactive, static content) may be converted to rich books automatically by the e-reader application using the search engine (e.g., discovered images, audio, video, links may be inserted in suitable places).

Furthermore, portions of content may be captured, copied, moved, in case of textual context recognized. These “snipped” portions of content may be displayed on a separate view pane and used like a directory (user can navigate to the location of snipped content by clicking on the snippet). Ink entries may be recognized and converted to text, although displayed ink may not be corrected for visual effect.

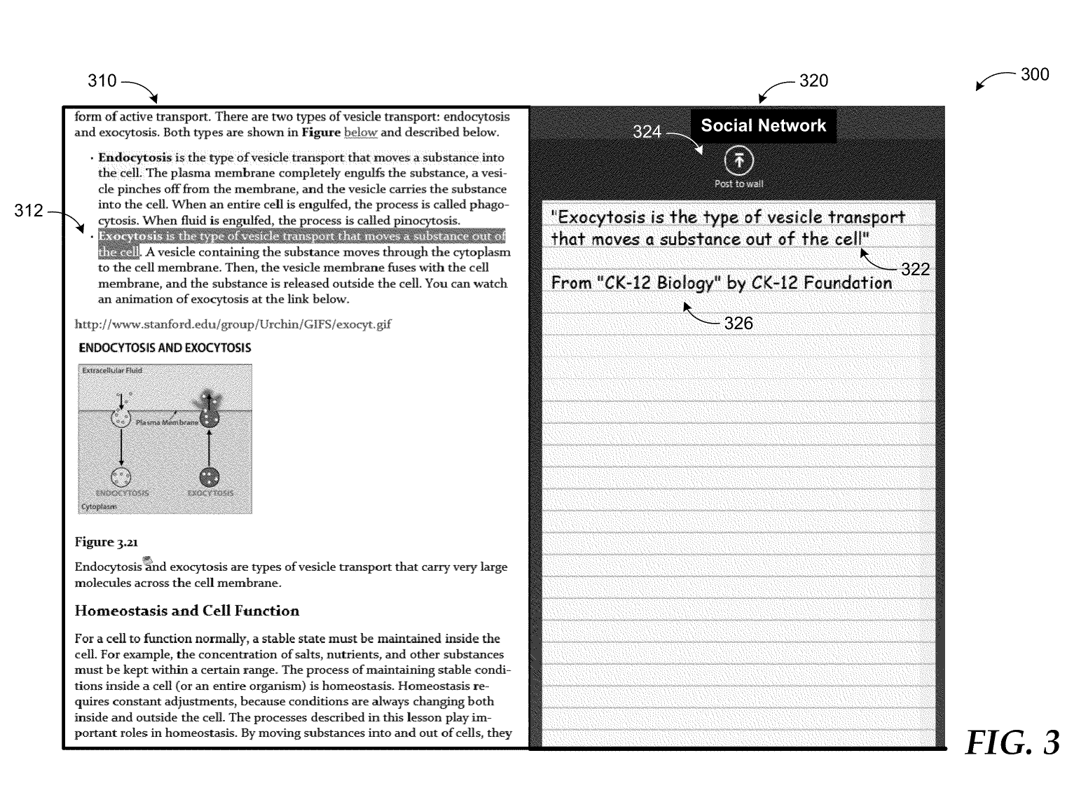

FIG. 3 illustrates a further example e-reader display with a commenting and/or sharing pane.

Diagram 300 shows an example e-reader user interface, where a book (or magazine) content 310 is displayed with textual and image elements and a notes/sharing pane 320 displaying user notes and content to be shared. For example, a user may select a portion of displayed content 312, which may be copied over to the notes/sharing pane 320 and made available for sharing. The user may share the copied portion of displayed content 322 by activating a share control 324 (e.g., clicking on a button), which may result in publication of the portion of displayed content at a social network, for example. In addition, users may be enabled to take notes 326 on the notes/sharing pane 320, which may be publishable as well.

Additionally, content and/or annotations may be shared on social networks, professional network, blogs, etc. through easy controls on the e-reader user interface. Personal and/or organizational document sources may be used to import documents into the user's library in same/similar format as books allowing the user to take advantage of enhanced reader capabilities. For example, PDF documents may be converted to EPUB format. A “send to reader” button on a browser or e-reader UI may enable a user to convert and store any document in their library.

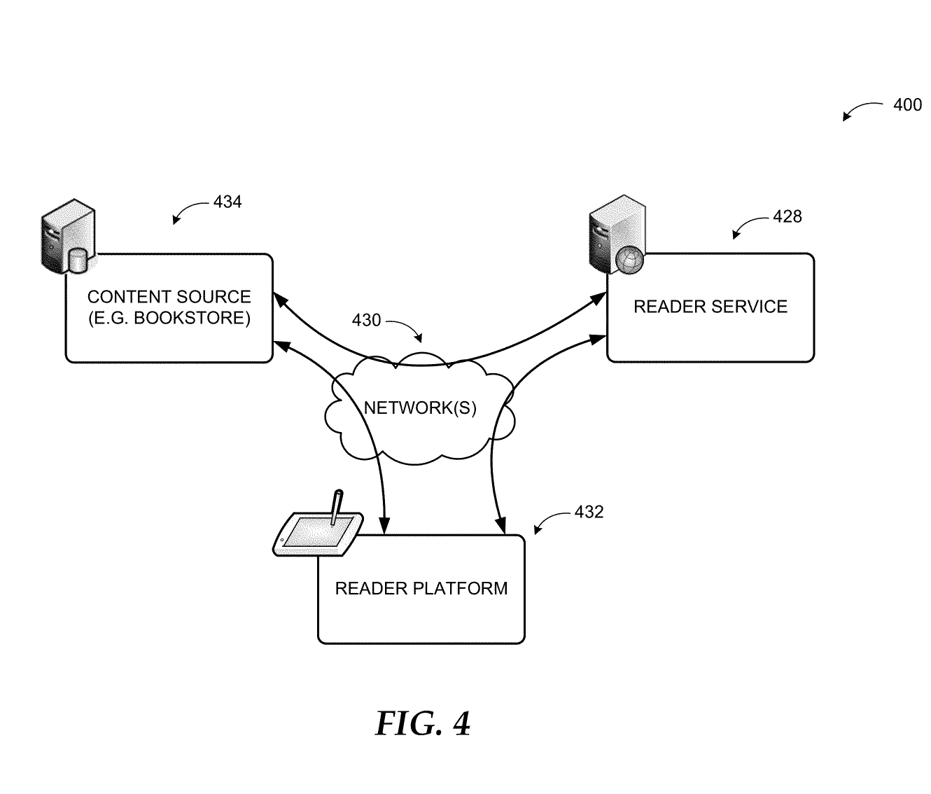

FIG. 4 illustrates major components and interactions in an example e-reader service architecture according to some embodiments.

As shown in diagram 400, a system according to embodiments may include three main components: content source 434, reader service 428, and reader platform 432. The different components may interact over one or more networks 430, which may include wired, wireless, enterprise, public, local, wide area, and other networks.

Content source 434 may also be referred to as store, where the user can access a catalog of books or other content available for purchasing and downloading to the local device. An e-reader application (local or hosted) may be provided to the user through the reader platform 432. The reader platform 432 may be a physical platform such as a stationary, handheld, mobile, or wearable computing device with a display (e.g., a tablet). The reader platform 432 may interact with the reader service 428 (backend service) to push/retrieve data. Locally stored data may be updated based on changes at the content source, reader service, and/or user actions.

Physical devices with touch, gesture (optically or otherwise captured), voice, gyroscopic, keyboard, mouse, pen, and comparable input mechanisms may be used as the reader platform 432. Thus, the architecture may accept any of these interaction methods. Furthermore, an e-reader application may be executed on multiple machines. When a user changes their device (e.g., from desktop to slate or from slate to smartphone), settings and content may be preserved (although adjusted based on device capabilities/characteristics). For example, annotations/notes may be anchored such that their relative position to the content is preserved even when display characteristics change (content is reflowed).

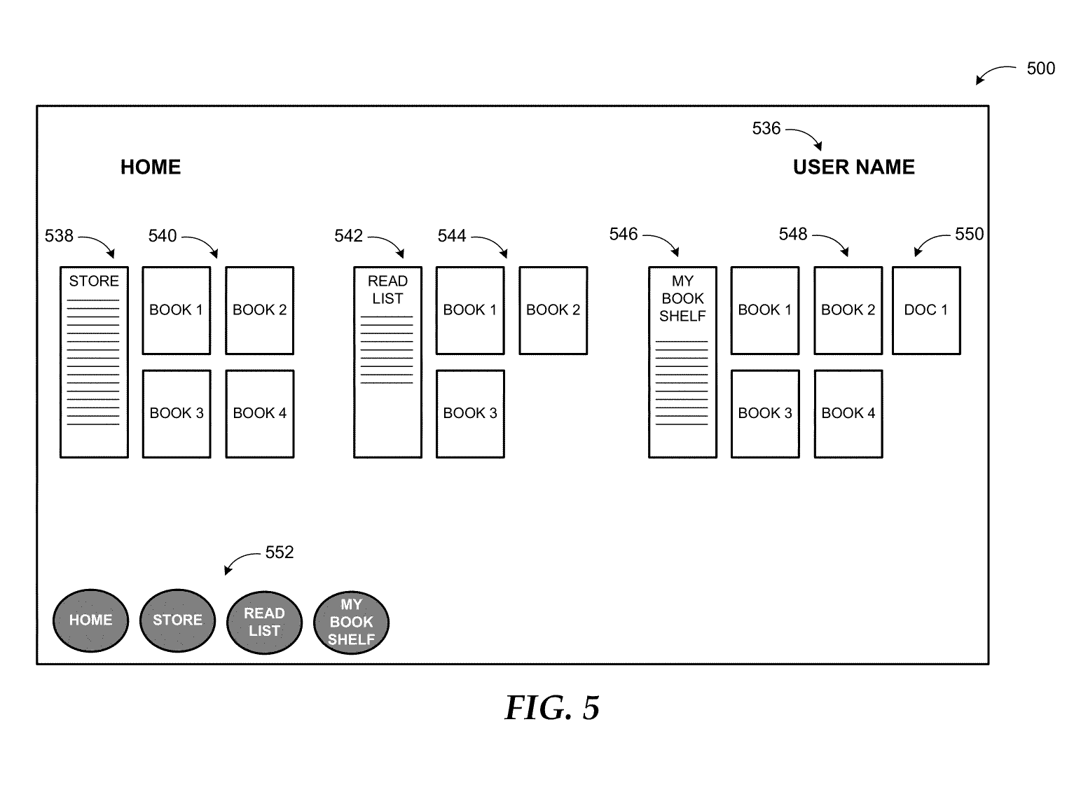

FIG. 5 illustrates an example home page view of an e-reader application user interface.

Diagram 500 shows an initial view of the e-reader application displaying books/documents/content available to the user through their own library(ies) and/or those available through one or more bookstores (content stores). Alternatively, the bookstore and my library views displaying content available for purchase/downloading and content already in the user's possession may be displayed on separate views. These views may be configurable and displayable based on user preferences.

In the example user interface of diagram 500, available content is grouped in three example categories: store 538, read list 542, and my bookshelf 546. In the store 538 group, a list of available books (or other content) may be displayed in addition to selected book covers 540 to provide the user a visual assistance. The read list 542 group may include a listing and selected book covers 544 of books (or other content) that are selected by the user. These items may be from the bookstore or from the user's local store. The my bookshelf 546 group may include a listing and selected books 548 that are available to the user locally (or through a hosted data store by the reader service), as well as other documents (e.g., document 550). As discussed previously, the e-reader application may enable a user to view and process (through note taking, sharing, annotating, etc.) books, magazines, self-created content, professional documents, and comparable content.

The example user interface also includes controls 552 such as view selection buttons for different views. Following commands may be available in different views of the e-reader application user interface. My Library: for switching the UI to the user local library where purchased books can be downloaded and read. Upload: for bringing up a picker dialog and allowing the user to upload PDF or DOCX files (unprotected). Uploaded files may be converted to reflowable content. Purchase: for exposing when a book is selected and making the book available for download from the library UI. Download: for making a local copy of the book purchased from store in the graphic user interface to visualize a book that has been purchased but not downloaded yet. Delete: for deleting a book from the library. Start: for reading a book or a document by activating it.

Based on content and service infrastructure following features may also be provided: book metadata on thumbnail (read, notes taken, last read, etc.); pivot/group/order titles by metadata elements (recentness of access, custom tags, size, annotation level, social comments); grid/list view; metadata detail window for selected book.

The core reading experience may include navigating content by touching the right or left gray bars, by swiping within the content, or by using the nav-tracker in the command bar; highlighting content of interest and initiate a quick note anchored to the highlighted text; initiating a full page note (by clicking annotate in the command bar or bringing a pen or similar device close to the surface if the device supports it); opening a previously added quick note by clicking on the ‘note’ marker near the content of interest; looking up content of interest by right clicking the content of interest and selecting ‘Lookup’—which pulls in web search results in an inline window; interacting with a modern object within the content, such as a scripted quiz or a video playback control; multiple books open with easy switching (tabs); searching that aggregates results in table of contents, content, own notes, social notes; zooming into a specific object (e.g. image); fuzzy searching (e.g. ‘table on biodiversity’); and/or options to set background, margin/gutter width, font, font size, color.

Specific search results may be explored further from within the results window—while the content of the book or document remains in view. The interactions may be specific to the object type and may include custom behaviors (e.g. advance a slide in a slide-show, or draw an arrow to related content in an image).

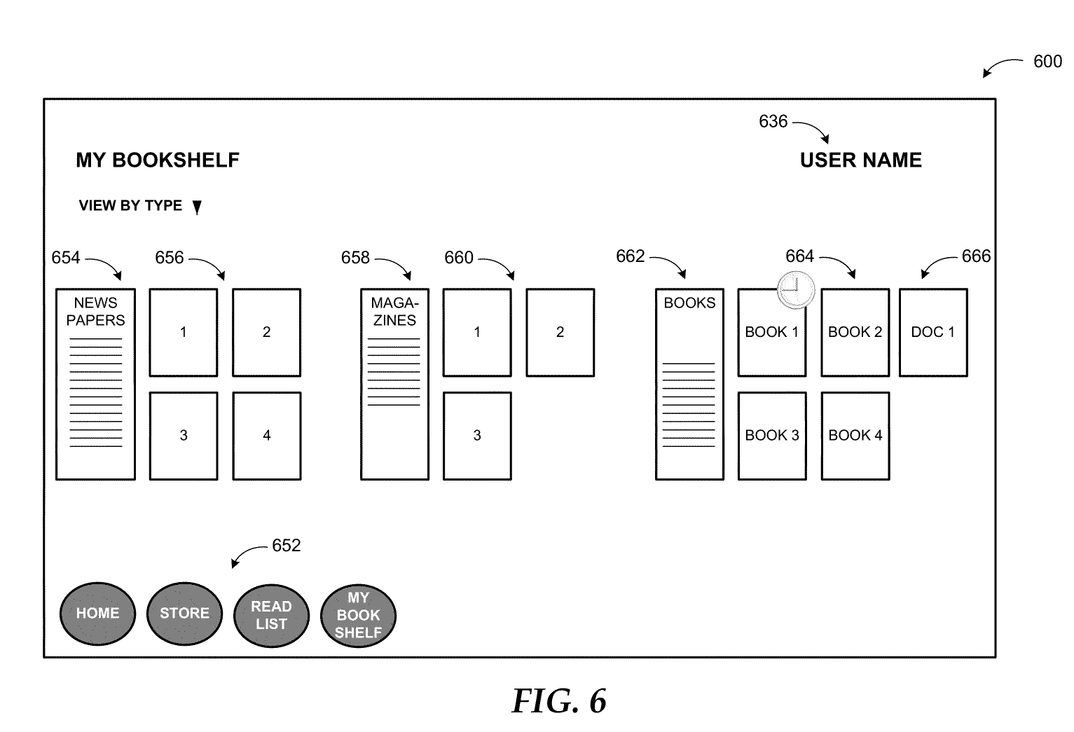

FIG. 6 illustrates an example my bookshelf page view of an e-reader application user interface.

Diagram 600 show the content available to the user grouped in a similar manner as in FIG. 5. User name 636 may identify the user with controls 652 providing access to other views. Available content may be grouped by newspapers 654 with example individual newspapers 656, magazines 658 with example individual magazines 660, and books 662 with example individual books 664. A clock icon may be overlaid on items which are soon to expire, such as rentals in the user collection that are almost finished. Additional groups may be available by opening a second page of the same view or by sliding the current view to left or right.

If a user has no bookshelf items then a teaser or “placeholder” may be presented to act as a draw to pull the user into an experience. The group headings may serve as links to jump into the groups themselves. As discussed above, the individual items shown in each group may contain one large item that is either editorially selected as featured, or is the newest arrival to the group, or the most recently read item. Larger displays may have additional vertical rows when four-small items or two-large items can fit.

Each group may have a “featured item” that is larger representing either editorial placement, or newly arrived to the user collection. User may be able to drill-down and drill-up through these groups with heading taps, clicks, and pinch/zoom. Below the page title may appear a “View by” drop list control acting as a sort. The options may vary as follows:

| Gallery | View by | Groups |
|---|---|---|
| Store | Title | Alphabet groups |
| | Author | Alphabet groups |
| | Publish date | this week, this month, this year, older |
| Reading List | Title | Alphabet groups |
| | Create date | this week, this month, this year, older |
| My Bookshelf | Title | Alphabet groups |
| | Author | Alphabet groups |
| | Publish date | this week, this month, this year, older |
| | Purchase date | this week, this month, this year, older |
| | Recently read | this week, this month, this year, older |

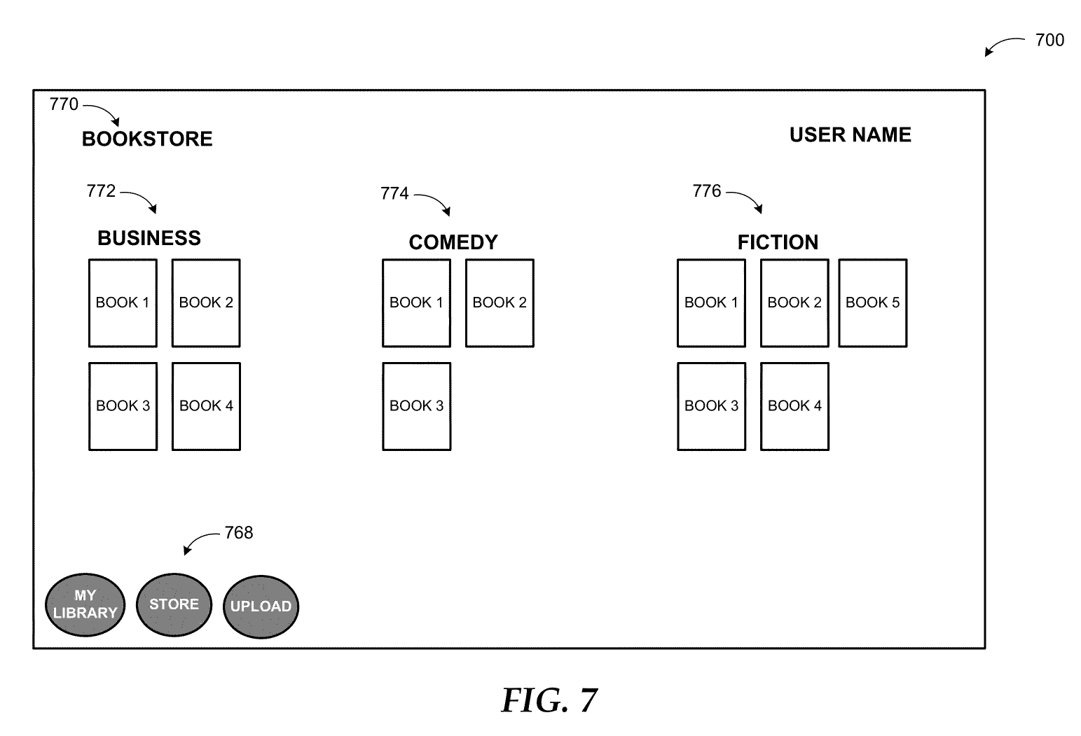

FIG. 7 illustrates an example bookstore view of an e-reader application user interface with available books sorted according to genre.

Diagram 700 shows a bookstore 770 view of the e-reader application user interface. Bookstore 770 is where the user can access a catalog of books (or other content) available for purchasing and downloading to the local device. The list of books may be arranged in categories driven by the metadata entered in the catalog. Categories may include genre such as business 772, comedy 774, and fiction 776. Other categories may be accessible through sliding the current view or switching to another page. Example controls 768 on the bookstore 770 view may include a link to My Library, a control for uploading a book, etc.

In some examples, “NEW” banners may be overlaid on items that are fresh arrivals to a gallery. A “click me” chicklet control may be implemented in galleries so mouse users can perform the pinch & zoom to navigate up through a layer of gallery depth.

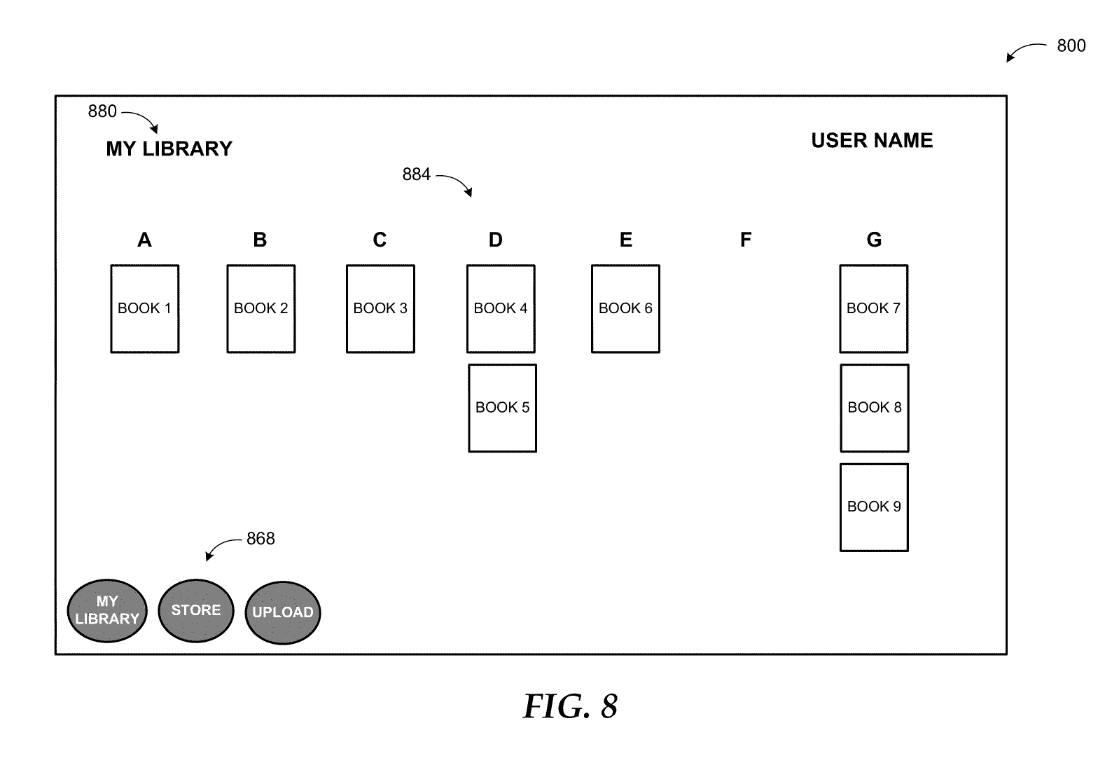

FIG. 8 illustrates an example my library view of an e-reader application user interface with available books sorted alphabetically.

Categorization of available content may take many forms such as genre (as shown in diagram 700), availability, content type, etc. Diagram 800 shows another example categorization of My Library 880 view of the e-reader application user interface. Available content (books) 884 are categorized alphabetically. Controls 868 are similar to the controls in other views. This categorization may be implemented similarly in each view or customized for each view.

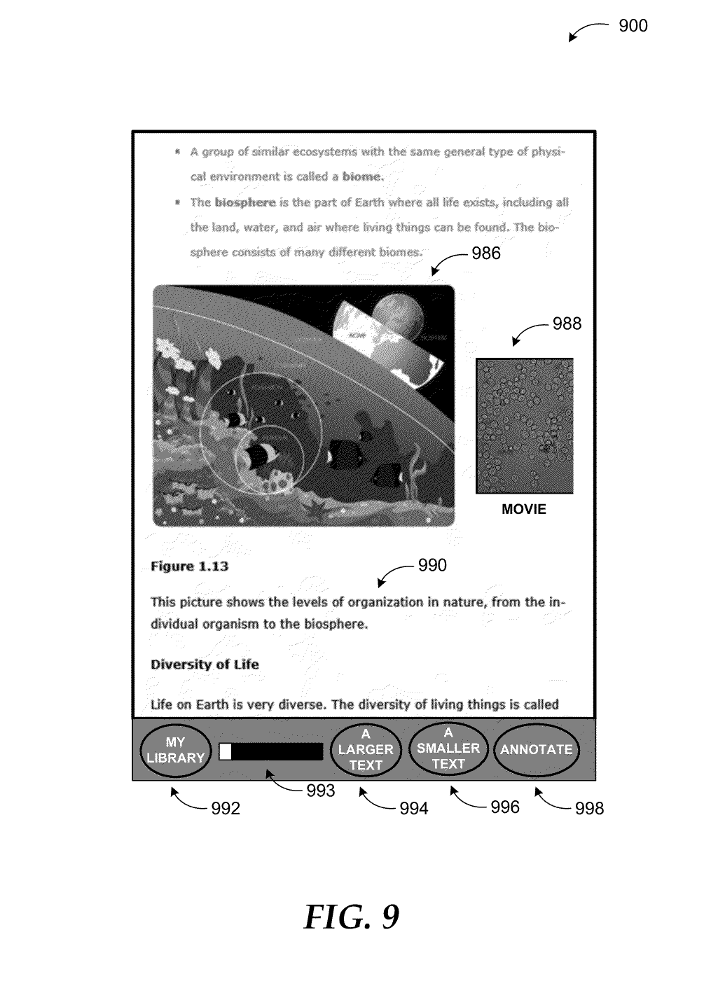

FIG. 9 illustrates an example e-reader application user interface with a variety of content and interaction controls for different types of content.

The example displayed content of an e-reader application in diagram, 900 includes textual content 990, image content 986, and video content 988. In addition to one or more links to other views (e.g., My Library 992), controls may be provided for processing the entire displayed content or portions of it (e.g., selected portions). For example, if a textual portion of the displayed content is selected, control 993 may be provided to adjust text size (for enhanced viewing) on a sliding scale. Similarly controls 994 and 996 may enable the user to adjust text size in steps. Annotation control 998 may enable the user to annotate the displayed content by entering ink or through a keyboard entry. When the user selects another portion of the displayed content, some or all of the controls may be replaced with other controls suitable for the newly selected portion of the displayed content.

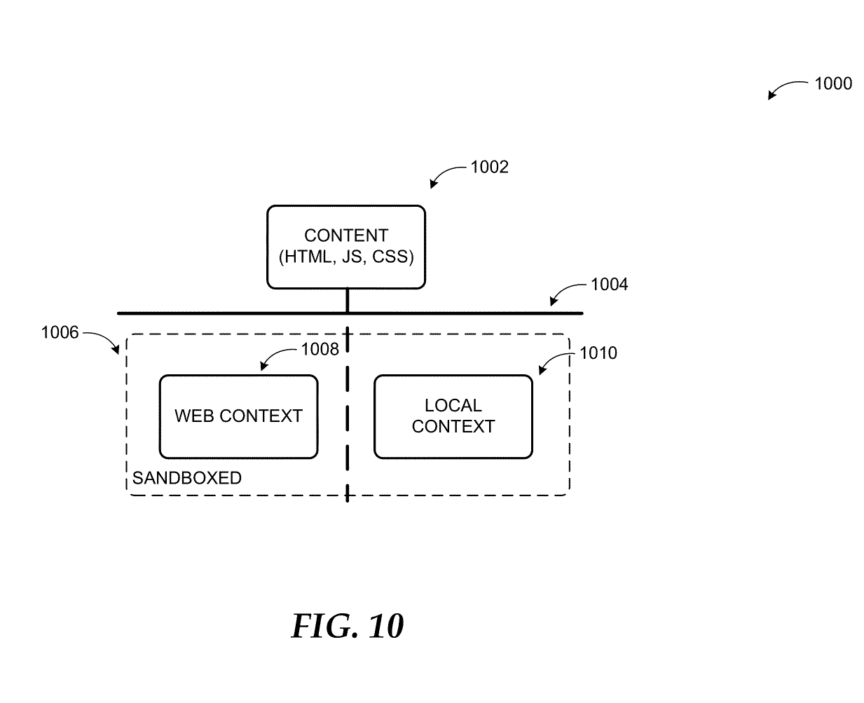

FIG. 10 conceptually illustrates secure processing of content through web context and local context.

Downloaded content may be sandboxed to protect against malicious or unsafe content. Content may be loaded using a web browser through navigation. Since local content is typically more highly trusted than website content, it may be processed differently. Downloaded untrusted content may be programmatically loaded and processed so that references do not cause errors (media, script, styles, etc. may be represented as blob objects).

Diagram 1000 shows the conceptual processing of the content 1002 in three example operations. First, scripts and style lists may be retrieved and inlined with the book HTML. For images, the reference may be marked as image (similar for audio/video objects). Next, local context 1010 may retrieve the inlined HTML, scan and find all instances of images and create a blob for each. Lastly, local context 1002 may replace the image references in the inlined HTML from the blob at the web context 1008. As discussed above, the downloaded content may be sandboxed (1006) providing separation (1004) from the original one.

The example systems in FIG. 1 through 10 have been described with specific devices, applications, user interface elements, and interactions. Embodiments are not limited to systems according to these example configurations. E-reader systems according to embodiments may be implemented in configurations employing fewer or additional components and performing other tasks. Furthermore, specific protocols and/or interfaces may be implemented in a similar manner using the principles described herein.

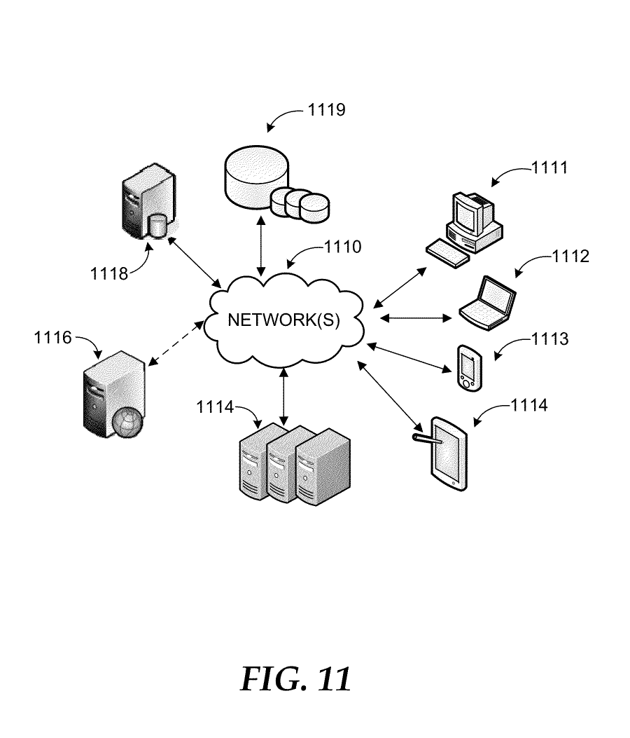

FIG. 11 is an example networked environment, where embodiments may be implemented. An e-reader architecture with rich service infrastructure may be implemented via software executed over one or more servers 1115 such as a hosted service. The platform may communicate with client e-reader applications on individual computing devices such as a tablet 1114, a smart phone 1113, a laptop computer 1112, or desktop computer 1111 (‘client devices’) through network(s) 1110.

Client applications executed on any of the client devices 1111-1114 may facilitate communications via application(s) executed by servers 1115 or on individual server 1116. An application executed on one of the servers may facilitate storage, protection, commercial exchange, and sharing of content through a set of compatible cross-platform consumption experiences that provide easy access to professional, institutional, collaborative or personal content with auxiliary capabilities such as search, commenting, posting, and similar ones. The application may store user and content date in data store(s) 1119 directly or through database server 1118.

Network(s) 1110 may comprise any topology of servers, clients, Internet service providers, and communication media. A system according to embodiments may have a static or dynamic topology. Network(s) 1110 may include secure networks such as an enterprise network, an unsecure network such as a wireless open network, or the Internet. Network(s) 1110 may also coordinate communication over other networks such as Public Switched Telephone Network (PSTN) or cellular networks. Furthermore, network(s) 1110 may include short range wireless networks such as Bluetooth or similar ones. Network(s) 1110 provide communication between the nodes described herein. By way of example, and not limitation, network(s) 1110 may include wireless media such as acoustic, RF, infrared and other wireless media.

Many other configurations of computing devices, applications, data sources, and data distribution systems may be employed to provide an e-reader architecture with rich service infrastructure. Furthermore, the networked environments discussed in FIG. 11 are for illustration purposes only. Embodiments are not limited to the example applications, modules, or processes.

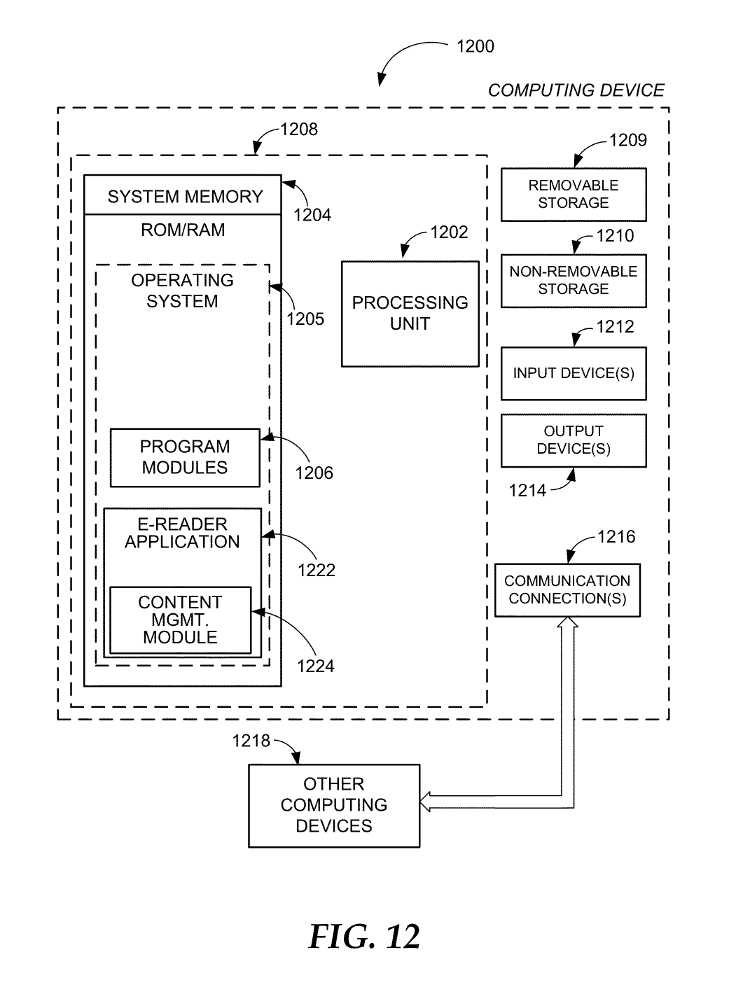

FIG. 12 and the associated discussion are intended to provide a brief, general description of a suitable computing environment in which embodiments may be implemented. With reference to FIG. 12, a block diagram of an example computing operating environment for an application according to embodiments is illustrated, such as computing device 1200. In a basic configuration, computing device 1200 may be any computing device executing an e-reader application according to embodiments (e.g., a tablet) and include at least one processing unit 1202 and system memory 1204. Computing device 1200 may also include a plurality of processing units that cooperate in executing programs. Depending on the exact configuration and type of computing device, the system memory 1204 may be volatile (such as RAM), non-volatile (such as ROM, flash memory, etc.) or some combination of the two. System memory 1204 typically includes an operating system 1205 suitable for controlling the operation of the platform, such as the WINDOWS® operating systems from MICROSOFT CORPORATION of Redmond, Wash. The system memory 1204 may also include one or more software applications such as program modules 1206, e-reader application 1222, and content management module 1224.

E-reader application 1222 may facilitate downloading, storage, display, sharing, and annotation of content such a books, documents, etc. In some embodiments, e-reader application 1222 in coordination with the content management module 1224 may download content from one or more stores and/or an e-reader service, display according to user preferences, and provide various views and control to enhance user experience. UC&C application 1222 and control module 1224 may be separate applications or integrated modules of a hosted service. This basic configuration is illustrated in FIG. 12 by those components within dashed line 1208.

Computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by removable storage 1209 and non-removable storage 1210. Computer readable memory devices may include volatile and nonvolatile, removable and non-removable physical media implemented in any method or technology for storage of information, such as computer readable instructions, data structures, program modules, or other data associated with e-reader content. System memory 1204, removable storage 1209 and non-removable storage 1210 are all examples of computer readable memory devices. Computer readable memory devices may include, but are not limited to, RAM, ROM, EEPROM, flash memory or other memory technology, CD-ROM, digital versatile disks (DVD) or other optical storage, magnetic tape, magnetic disk storage or other magnetic storage devices, which can be used to store the desired information and which can be accessed by computing device 1200. Any such computer readable memory device may be part of computing device 1200. Computing device 1200 may also have input device(s) 1212 such as keyboard, mouse, pen, voice input device, touch input device, and comparable input devices. Output device(s) 1214 such as a display, speakers, printer, and other types of output devices may also be included. These devices are well known in the art and need not be discussed at length here.

Computing device 1200 may also contain communication connections 1216 that allow the device to communicate with other devices 1218, such as over a wired or wireless network in a distributed computing environment, a satellite link, a cellular link, a short range network, and comparable mechanisms. Other devices 1218 may include computer device(s) that execute communication applications, web servers, and comparable devices. Communication connection(s) 1216 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

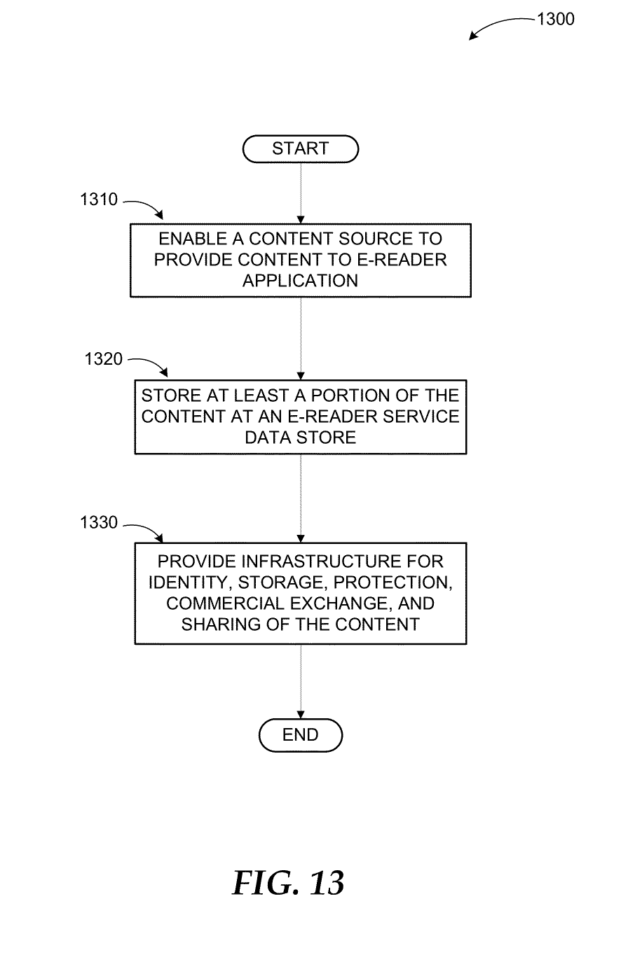

FIG. 13 illustrates a logic flow diagram for a process of providing an e-reader service according to embodiments. Process 1300 may be implemented on a stationary or portable computing device.

Process 1300 begins with operation 1310, where one or more content sources (e.g., a bookstore) to provide content directly or through a cloud-based reader service to an e-reader application. At operation 1320, at least a portion of the content associated with the e-reader application may be stored at a data store managed by the cloud-based reader service. The content may include one or more of electronic books, magazines, articles, professional content, institutional content, personal content, and collaborative content.

At operation 730, a rich service infrastructure may be provided by the cloud-based reader service for identity, storage, protection, commercial exchange, and sharing of the content through a set of compatible cross-platform consumption experiences. The consumption experiences may include one or more of a core reading experience, a note taking experience, a research experience, a reference experience, a social sharing experience, and an aggregation experience for user created content with the professional content.

The operations included in process 1300 are for illustration purposes. Providing an e-reader service may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method at least partially executed on a computing device for providing an electronic reading experience, the method comprising:
enabling one or more content sources to provide content directly or through a cloud-based reader service to an e-reader application; and
storing at least a portion of the content associated with the e-reader application at a cloud-based data store managed by the cloud-based reader service, wherein the content includes one or more of electronic books, magazines, articles, professional content, institutional content, personal content, and collaborative content.

2. The method of claim 1, further comprising:
providing a rich service infrastructure at the cloud-based reader service for identity, storage, protection, commercial exchange, and sharing of the content through a set of compatible cross-platform consumption experiences.

3. The method of claim 2, wherein the consumption experiences include one or more of: a core reading experience, a note taking experience, a research experience, a reference experience, a social sharing experience, and an aggregation experience for user created content with the professional content.

4. The method of claim 1, further comprising:
enabling one or more of browsing a book store and purchasing a book for downloading to a client device; rendering content in a standardized format; rendering content with images, audio/video replays, and interactivity; adjusting displayed content size for enhanced readability; creating text annotations anchored to specific content; creating full page notes anchored to a specific page in the book; markup of content of interest by highlighting or underlining; recalling notes or annotations when the content of interest is in view; synchronizing annotations and full page notes across one or more devices executing the e-reader application; look-up of the content of interest with web search results shown within a reading experience; and search of content of the books and notes along with a web search during the look-up.

5. The method of claim 1, further comprising:
enabling one or more of customization of a reading experience through one or more of a page background, a line spacing, a margin, a gutter width, and a text color; customization of user generated content through one or more of an ink color, a stroke width, an eraser width, a text color, a font type, and a font size; selection of an area of displayed content and dragging of the selected content to a note taking pane; addition of existing or captured audio/video stream to notes; formatting of notes with modification of one or more of a font style, a font color, a font size; exporting of annotations to another program capable of receiving one or more annotation content types; synchronizing the annotations to a pre-configured friends' book; conducting of a live chat from within the reader experience; sharing a hyperlink that links to annotation and content of interest through one of email and by posting to a social web site; and sharing the displayed content with real time annotations appearing during a chat session.

6. The method of claim 1, further comprising:
enabling a user to interact with provided content and forwarding user input to one of the content source and a designated destination.

7. The method of claim 1, further comprising:
enabling execution of the e-reader application on multiple client devices; and
preserving settings and displayed content when a user changes their client device, wherein the displayed content is adjusted based on client device capabilities and characteristics.

8. The method of claim 7, further comprising:
reflowing the content and anchoring annotations and notes such that their relative position to the displayed content is preserved when display characteristics change.

9. The method of claim 1, further comprising:
enabling sharing of at least one of the content, notes, and annotations on one or more of a social network, a professional network, and a blog through activation of a control on an e-reader application user interface.

10. The method of claim 1, further comprising:
enabling user interaction with displayed content through one or more of a touch, an optically captured gesture, a voice input, a gyroscopic input, an eye-tracking input, a keyboard input, a mouse input, and a pen input at the e-reader application.

11. The method of claim 1, further comprising:
updating locally stored data at a client device based on changes at one or more of the content source, the cloud-based reader service, and user actions.

12. A server for providing an electronic reading experience, the server comprising:
a memory;
a processor coupled to the memory, the processor executing an e-reader service in conjunction with instructions stored in the memory, wherein the e-reader service is configured to:
enable one or more content sources to provide content directly or through the e-reader service to an e-reader application; and
store at least a portion of the content associated with the e-reader application at a cloud-based data store managed by the e-reader service, wherein the content includes one or more of electronic books, magazines, articles, professional content, institutional content, personal content, and collaborative content.

13. The server of claim 12, wherein the e-reader application is executed at the e-reader service and provided to one or more client devices in a hosted manner.

14. The server of claim 13, wherein the e-reader service is further configured to:
enable sandboxing of downloaded content at the e-reader application to protect against malicious or unsafe content.

15. The server of claim 13, wherein the e-reader service is further configured to:
enable retrieval of scripts and style lists;
inline the retrieved scripts and style lists with content code;
enable marking of a reference for an image as image;
enable retrieval of the inlined content code by a local context,
enable scanning and finding of instances of images and creation of a blob for each instance; and
enable replacement of the image references by the local context in the inlined content code from the blob at a web context.

16. The server of claim 13, wherein processing is performed at a time of creation at the e-reader application for personal documents created or received from one of a personal domain and an organizational domain, and a portion of processing is performed at the content source and another portion of the processing is performed at the e-reader application for books.

17. The server of claim 12, wherein the data is exchanged between the e-reader service and the e-reader application through one of push from the e-reader service and demand from the e-reader application.

18. A computer-readable memory device with instructions stored thereon for providing an electronic reading experience, the instructions comprising:
enabling one or more content sources to provide content directly or through a cloud-based reader service to an e-reader application;
storing at least a portion of the content associated with the e-reader application at a cloud-based data store managed by the cloud-based reader service, wherein the content includes one or more of electronic books, magazines, articles, professional content, institutional content, personal content, and collaborative content; and
providing a rich service infrastructure at the cloud-based reader service for identity, storage, protection, commercial exchange, and sharing of the content through a set of compatible cross-platform consumption experiences, wherein the consumption experiences include one or more of: a core reading experience, a note taking experience, a research experience, a reference experience, a social sharing experience, and an aggregation experience for user created content with the professional content.

19. The computer-readable memory device of claim 18, wherein the instructions further comprise:
enabling implementation of one or more visual schemes to display available content including a 3D scheme, a shading scheme, a color scheme, a textual scheme, a graphical scheme, an audio feature, and a video feature.

20. The computer-readable memory device of claim 18, wherein the instructions further comprise:
enabling display of available content through one or more views grouping the available content according to predefined categories at an e-reader application user interface.
